(19) United States
(12) Patent Application Publication
(10) Pub. No.: US 2010/0166371 A1
(43) Pub. Date: Jul. 1, 2010

(54) FIBER OPTIC CONNECTION DEVICE FOR COMPOSITE STRUCTURES

(75) Inventors: Carlos MIGUEL GIRALDO, Madrid (ES); Julio Orcha Villacorta, Madrid (ES); Manuel Paton Gutierrez, Madrid (ES); Rafael Contento Tercedor, Madrid (ES)

Correspondence Address: LADAS & PARRY LLP, 26 WEST 61ST STREET, NEW YORK, NY, 10023, US

(73) Assignee: AIRBUS ESPANA S.L.

(21) Appl. No.: 12/426,340

(22) Filed: Apr. 20, 2009

(30) Foreign Application Priority Data
Dec. 30, 2008 (ES) 200803748

(51) Int. Cl. G02B 6/38

(52) U.S. Cl. 385/56; 385/55

(57) ABSTRACT

The invention relates to a device (1) for connecting at least one optical fiber (7) embedded in a composite structure (50), said device (1) comprising a first connection element (2) which is embedded in the mentioned composite structure (50), internally comprising said at least one optical fiber (7), characterized in that the device (1) further comprises:
a protecting element (3) which is attached to the first connection element (2) during the manufacture and assembly of the composite structure (50), being embedded therein, such that it prevents the penetration of resin in the mentioned first connection element (2) during the curing of said structure (50);
a second connection element (4) comprising at least one optical fiber lead (7) and an elastic element (14), said second connection element (4) being attached to the first connection element (2) after the removal of the protecting element (3) once the curing of the structure (50) has ended, making the mentioned structure (50) start to operate, the at least one optical fiber (7) of the first connection element (2) and of the second connection element (4) thus being connected as a result of the elastic element (14).

### FIELD OF THE INVENTION

The present invention relates to a fiber optic connection device, particularly for optical fiber embedded in a composite structure.

### BACKGROUND OF THE INVENTION

Within the field of instruments in engineering, fiber optic-based sensors are increasingly advancing with regard to conventional instruments, becoming for certain specific applications virtually the only solution. Within the family of fiber optic-based sensors, Bragg network-based sensors are in a predominant position and have an incredible potential. This technology is particularly being developed, among other applications, for measuring and monitoring structural deformations in different types of structures.

In the case of aeronautical structures, in which the use of composites is increasingly extensive, the use of this type of instruments provides unique possibilities. In addition to allowing the design and manufacture of the layer configuration necessary for obtaining optimal mechanical properties for their application, the inherent manufacturing process for composites enables incorporating optical fibers during the actual production process and within the material which, after polymerization of the composite, form a unique material-sensor system which contributes to reaching the concept of intelligent materials in which said materials are first of all capable of detecting in order to then react against external excitations.

This highly sought concept, which is justified from a technological point of view and viable from a theoretical point of view, in practice is considerably difficult to implement on an industrial level. The problem is focused on the intermediate face between different materials. The aforementioned problem in the particular case of composite structures in which fiber optic sensors are embedded is in the transition between the composite, comprising the embedded optical fiber, and the external transmitting optical fiber. This area of the composite structure comprising optical fiber as a line of sensors for monitoring the mentioned structure, which is absolutely essential from a functional point of view for communicating the network of sensors of the composite structure with the external monitoring and acquisition unit, is a very important feature first due to the actual difference of geometric and mechanical properties of the composite and the optical fiber, the mentioned area introducing a particularly delicate point in the composite structure.

Furthermore, it is necessary to take into account that in most cases and for most composite structures, a flow of excess resin occurs during the curing process which reduces the thickness towards the edges of the structure, changing the dimensions thereof. This effect makes it necessary to trim the edges of the structure which, in the case of a composite structure comprising optical fiber as a line of monitoring sensors, in which the mentioned optical fiber protrudes to the exterior at the edge thereof, poses the particular problem of destroying the fiber, whereby destroying the continuity between the sensors embedded in the structure and the external monitoring and acquisition unit.

Patent document U.S. Pat. No. 6,035,084 discloses a fiber optic connector for connecting a fiber embedded in a composite structure. The mentioned connector is not embedded in the structure, but rather connects with the fiber embedded therein with the aid of a lens allowing the correct alignment between the fiber and the connector. This type of connector, however, cannot be embedded in the structure since it is too large and complex and compromises the previous structural integrity. In addition, since it is necessary that part of the embedded fiber protrudes to the exterior, there is a problem of damaging said optical fiber when any operation for trimming the edges of the structure is performed.

Patent document EP 1258760 discloses a fiber optic connector which can be embedded in a composite structure. Said connector comprises two ferrules, an external ferrule with optical fibers which must be connected, the external fiber being able to be easily and quickly disconnected by removing the external ferrule, while at the same time it can be reconnected by reinserting the external ferrule in the mentioned connector. A connector of this type however does not solve the problem of trimming the edges of the composite structure without damaging the optical fiber. In addition, the system proposed in this document comprises cutting the connector and the structure for the subsequent connection with the optical fiber lead, which presents a number of cutting or planing difficulties and problems since the materials of the structure and of the connector are so different. Another problem presented by such a device is that the resin penetrates inside the connector on many occasions during the curing process for the structure, reaching the first area thereof and thus damaging the optical contacts contained therein and making the subsequent connection thereof with the optical fiber lead impossible. Furthermore, no solution whatsoever for rigidizing the fiber optic connector once it starts to operate is described in the mentioned patent document EP 1258760.

It is therefore necessary to develop a connection device which on one hand allows the connection and disconnection of the fiber lead as a line of monitoring sensors in a composite structure quickly and easily, which aids in reducing the risks of fiber breakage during the steps of manufacture and assembly thereof in the structure in which it is embedded, while at the same time it allows planing the edges of the previous structure without damaging or breaking the mentioned fiber lead to which an external monitoring and acquisition unit is to be connected.

The present invention aims to solve the previously mentioned drawbacks.

### SUMMARY OF THE INVENTION

The invention thus develops a device for connecting optical fiber embedded in a composite structure such that said device will be partially embedded therein during the manufacturing process for the structure. The connection device of the invention is partially embedded in the area right before the point where the fiber protrudes from the composite structure, either through the edge of the structure or through the surface of the structure, such that said device allows the connection and disconnection of the embedded fiber while at the same time preventing problems of breakage of said fiber when the edges of the structure are planed.

The developed invention is based on the initial preparation of the optical fiber or fibers that will be embedded within the layers of the composite structure to be monitored during the manufacture of the mentioned structure.

The initial preparation of the fiber or fibers presents two possibilities: the embedded connection device allows access to a single optical fiber embedded in the structure, or the connection device allows accessing more than one optical fiber. Both solutions are identical on a conceptual level, the only differences being the alignment of the fiber and the size of the housings.

The connection device of the invention comprises the following elements:
a first connection element which is embedded in the composite structure, either on the edge or on the surface of said structure;
a protecting element which is attached to the first connection element during the manufacture and assembly of the composite structure, being embedded in the mentioned structure, such that said protecting element prevents the penetration of resin in the mentioned first connection element during the curing of the structure since it is perfectly sealed with respect to said first connection element, this protecting element being removed once the structure is cured; another feature of this protecting element is that it must be designed and installed during the manufacturing process such that resin does not stick to its external surface during the curing process for the structure, such that once the structure is cured, the mentioned protecting element can be easily removed from the first connection element;
a second connection element which is attached to the first connection element after removing the previous protecting element once the composite structure starts to operate;
a mechanical protection element which is attached to the second connection element and the purpose of which is to mechanically protect the first and second connection elements, such that the stresses of any mechanical aggression are absorbed by this protection element.

Other features and advantages of the present invention will be understood from the following detailed description of an illustrative embodiment of its object in relation to the attached drawings.

### DESCRIPTION OF THE DRAWINGS

FIG. 1 is a schematic view of the first connection element and the components thereof in the fiber optic connection device according to the invention.

FIG. 2 is a schematic view of the protecting element of the first connection element in the fiber optic connection device according to the invention.

FIGS. 3a and 3b show a schematic view and an exploded view, respectively, of the assembly of the first connection element and its protecting element in the fiber optic connection device according to the invention.

FIGS. 4a and 4b show a schematic view and an exploded view, respectively, of a first embodiment of the second connection element in the fiber optic connection device according to the invention.

FIGS. 5a and 5b show plan and elevational views of a first embodiment of the mechanical protection element in the fiber optic connection device according to the invention.

FIGS. 6a and 6b show an exploded view and a schematic view, respectively, of the assembly of the first connection element and a first embodiment of the protecting element thereof in the fiber optic connection device according to the invention.

FIGS. 7a and 7b show an exploded view and a schematic view, respectively, of the assembly of the first connection element and a second embodiment of the protecting element thereof in the fiber optic connection device according to the invention.

FIGS. 8a, 8b and 8c show a schematic view and an exploded view, respectively, of a second embodiment of the first and second connection elements in the fiber optic connection device according to the invention.

FIGS. 9a, 9b, 10a and 10b show plan and elevational views of the second embodiment of the mechanical protection element of the connection device of the invention.

FIGS. 11a, 11b and 11c show plan, elevational and section views of a third embodiment of the mechanical protection element of the connection device of the invention.

FIGS. 12a and 12b show a schematic view and an exploded view, respectively, of the complete assembly of the fiber optic connection device of the invention according to a first embodiment thereof.

FIGS. 13a and 13b show a schematic view and an exploded view, respectively, of the complete assembly of the fiber optic connection device of the invention according to a second embodiment thereof.

FIG. 14 shows an example of a general schematic view of the commissioning of a fiber optic connection device according to the invention.

FIGS. 15a and 15b show how the fiber optic connection device of the invention is embedded in the composite layers when this device is embedded on the edge of the mentioned composite structure.

FIGS. 16a and 16b show how the fiber optic connection device of the invention is embedded in the composite layers when this device is embedded on the surface of the mentioned composite structure.

### DETAILED DESCRIPTION OF THE INVENTION

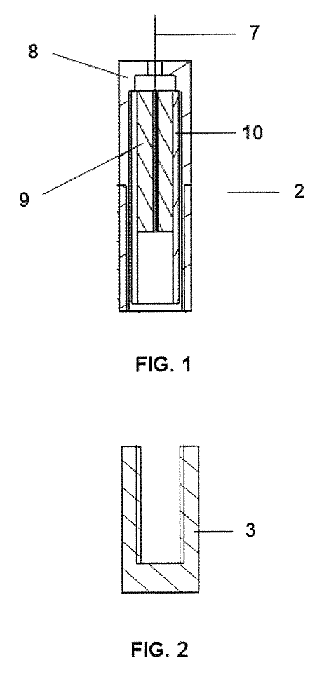

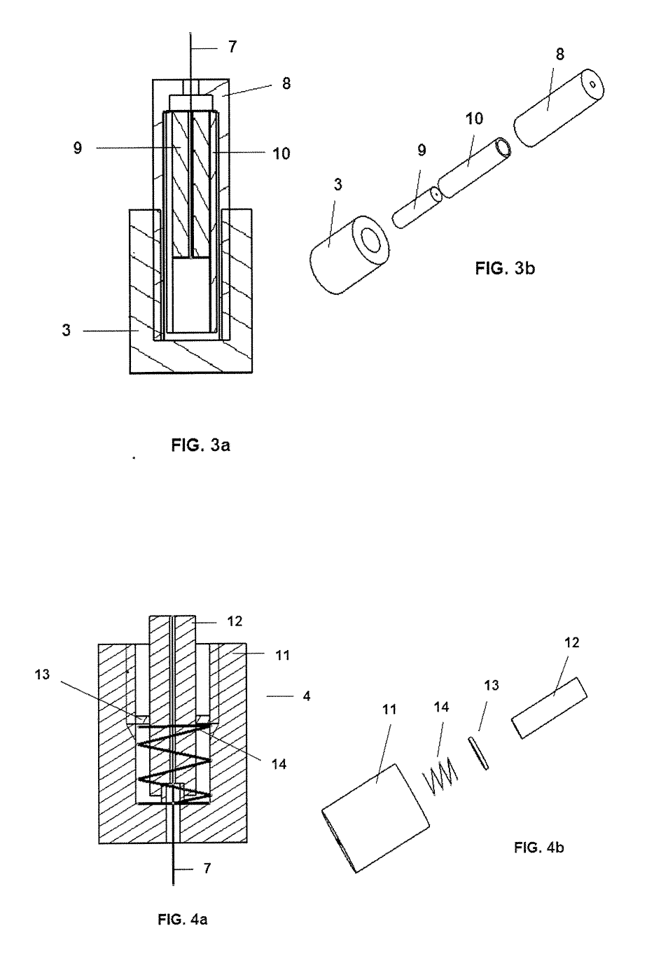

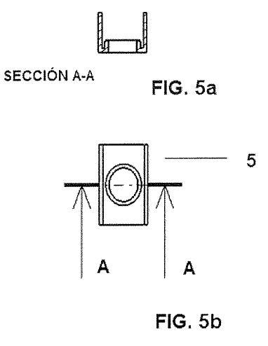

The invention thus develops a device for connecting optical fiber embedded in a composite structure 50, such that the connection device 1 comprises the following elements:
a first connection element 2 (FIG. 1) which is embedded in the composite structure, either on the edge or on the surface of said structure, the internal components of said element 2 having to necessarily been prepared previously through a suitable polishing and cleaning process which allows the correct alignment of the two cores of the optical fibers to be connected, the embedded optical fiber and the optical fiber lead 7 contained in the first connection element 2;
a protecting element 3 which is attached to the first connection element 2 during the manufacture and assembly of the composite structure such that it prevents the penetration of the flow of resin in the mentioned first connection element 2 during the curing of the composite structure;
a second connection element 4 which is attached to the first connection element 2 after removing the protecting element 3 once the composite structure starts to operate and the embedded optical fiber is connected with the optical fiber lead 7;
a mechanical protection element 5 which is attached to the second connection element 4 and the purpose of which is to mechanically protect the first and second connection elements 2 and 4, such that the stresses of any mechanical aggression (vibrations, shocks, etc.), mainly shear stresses, are absorbed by this element 5. The mentioned element 5 is fixed to the composite structure through a fixed attachment, as shown in FIGS. 5a and 5b, for a determined range of material thicknesses, or a removable-type attachment, so that it can be used in a range of thicknesses, FIGS. 11a, 11b and 11c.

The elements forming the connection device 1 of the invention are described below in more detail.

### First Connection Element 2

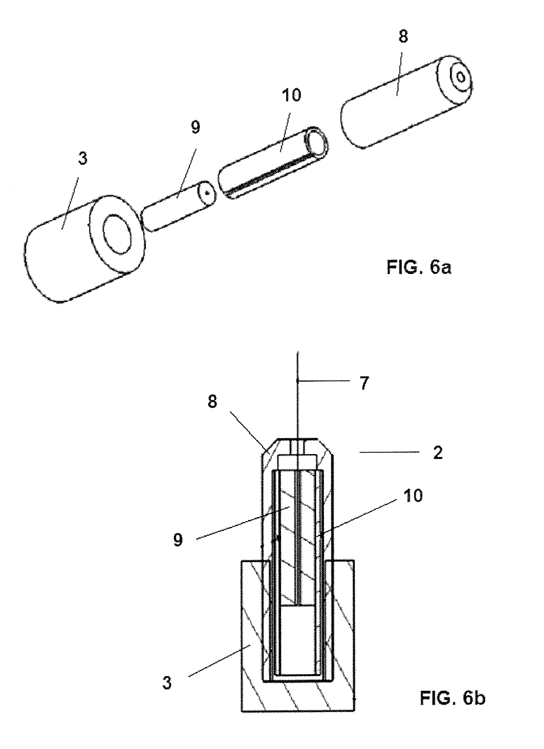

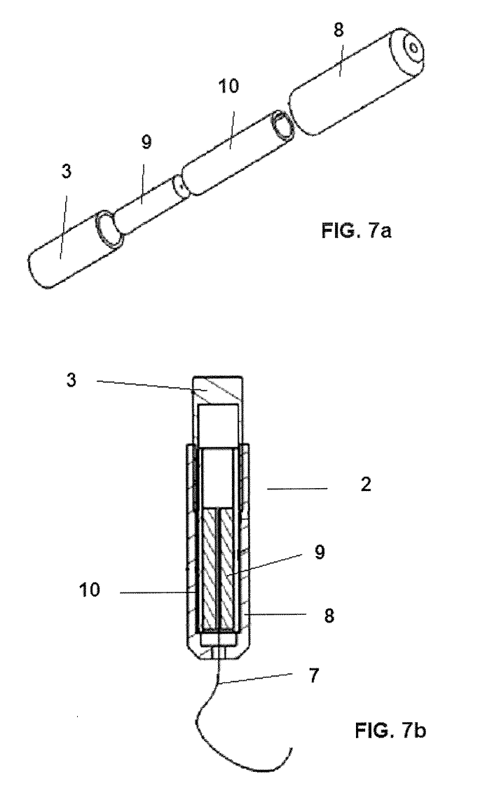

The first connection element 2 comprises two essential preferred embodiments, as can be seen in FIGS. 6a and 6b, and FIGS. 7a and 7b. The main difference between both embodiments is that for the embodiment shown in FIGS. 6a and 6b, the first connection element 2 and the protecting element 3 are attached by means of an external threaded attachment, whereas for the embodiment shown in FIGS. 7a and 7b, elements 2 and 3 are attached through an internal threaded attachment.

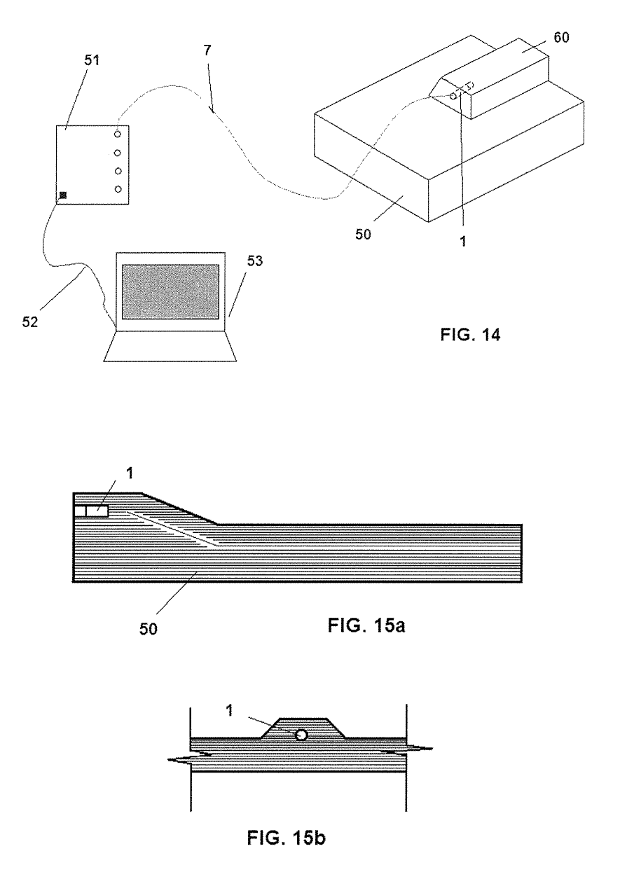

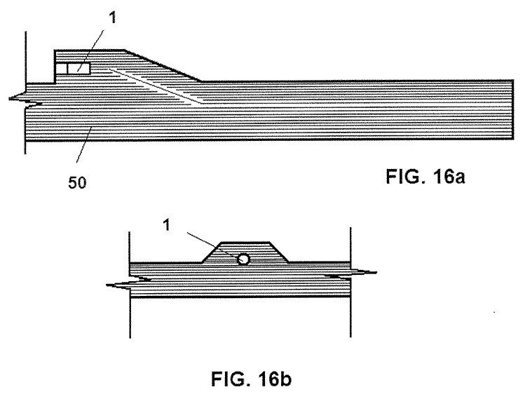

In any of the two embodiments, the first connection element 2 comprises the following sub-elements: a tubular element 8, inside which there is arranged a highly rigid element 9 with very narrow tolerances, said element 9 comprising a concentric internal through borehole internally housing the optical fiber 7 which will be embedded in the composite structure and which will be connected with the optical fiber already embedded therein, and an external tubular element 10 acting as a guiding sleeve for directing and centering the cores of the optical fibers to be connected, in connection with the external monitoring and acquisition unit 53, through a transmission line 52 and an interrogator device 51 (FIG. 14) once the structure 50 with the device 1 starts to operate. The optical fiber is rigidly attached to the previous element 9, in its concentric internal through borehole. Furthermore, the mentioned optical fiber 7 comprises a network of Bragg sensors engraved along the length thereof in different locations. Element 9 is preferably a ceramic element. The external, preferably ceramic tubular element 10 is adapted concentrically to the mentioned also preferably ceramic element 9.

### Protecting Element 3

The protecting element 3, consistent with the first connection element 2, comprises two essential preferred embodiments, the first embodiment as shown in FIGS. 6a and 6b, where the threaded attachment between the first connection element 2 and the protecting element 3 is external, and the second embodiment, as shown in FIGS. 7a and 7b, where the threaded attachment between the first connection element 2 and protecting element 3 is internal, the terms external and internal referring to the threading with respect to the first connection element 2. The protecting element 3 in either of its two embodiments, merely has a function of protecting the optical contact of the embedded fiber 7, but its design must be suitable to perfectly block the flow of resin, and it has a surface treatment which aids in the resin not sticking thereto during the curing process for the structure 50, such that, once the mentioned structure 50 is cured, the protecting element 3 can be easily removed from the first connection element 2 of the composite. Another feature of this protecting element 3 is that it must be designed such that resin does not stick to its external surface.

Basically, the protecting element 3 is a lid comprising an internal or external thread, according to the attachment to be done with the first connection element 2 in order to obtain a suitably threaded attachment with the first connection element 2.

### Second Connection Element 4

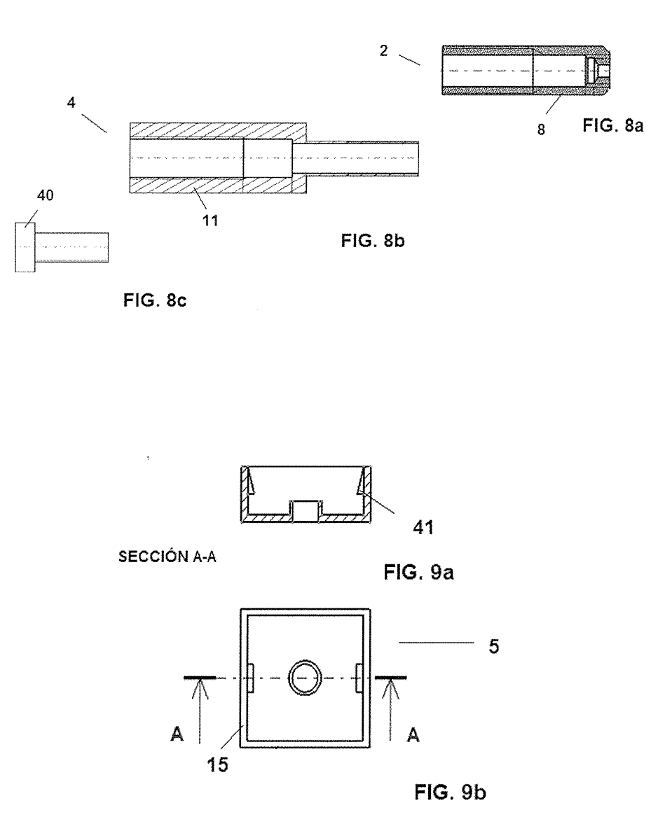

The mentioned second connection element 4, like the first connection element 2 and the protecting element 3, comprises two embodiments, one for the attachment with the first connection element 2 through the external threaded attachment (FIGS. 4a and 4b), and another one for the attachment with the first connection element 2 through the internal threaded attachment (FIGS. 8a, 8b and 8c).

In the first embodiment (FIGS. 4a and 4b), in which there is an external threaded attachment between the first connection element 2 and the second connection element 4, the subsequent planing performed in the composite structure 50 is partial, and cannot be performed in the area in which the device 1 is housed. This embodiment thus solves the optical fiber connection problem when it is not necessary to plane the structure 50, or when this planing can be performed avoiding the area in which the device 1 is arranged. Furthermore, this embodiment is useful when a planing must be done in the structure 50 and the optical fiber protrudes through the surface, the device 1 being in the structure 50, specifically in a reinforcement 60.

In addition, in the second embodiment (FIGS. 8a and 8b), in which there is an internal threaded attachment between the first connection element 2 and the second connection element 4, the planing issue is completely solved for both the case in which the device 1 is placed on the edge or on the surface of the structure 50, since there is no external limitation or stop for the mentioned planing because the elements 2 and 4 are connected inside the structure 50. Furthermore, this planing can be done by having previously removed the protecting element 3 or without having previously removed it, depending on if the strength of the first connection element 2 is sufficient to withstand said planing.

Regardless of the type of threaded attachment used, the mentioned second connection element 4 comprises the following sub-elements: a tubular element 11, inside which there is arranged a highly rigid element 12 with very narrow tolerances, said element 12 comprising a concentric internal through borehole internally housing the optical fiber 7 which will be connected with the external measurement equipment 53 (the second connection element 4 is in turn concentrically adapted to the external tubular element 10 of the first connection element 2), a stop 13 rigidly stuck to the second connection element 4, and an elastic-type damping element 14, typically a spring, in turn comprising a concentric internal through borehole with the entrance of the optical fiber 7. The stop has an internal diameter identical to the external diameter of the element 12, and an external diameter such that it serves as a side base for the damping element 14, also housed in the tubular element. The damping element 14 is opposite on the opposite end to the internal planar face of the tubular element 11, which in turn has a concentric through borehole for the entrance of the optical fiber 7.

### Mechanical Protection Element 5

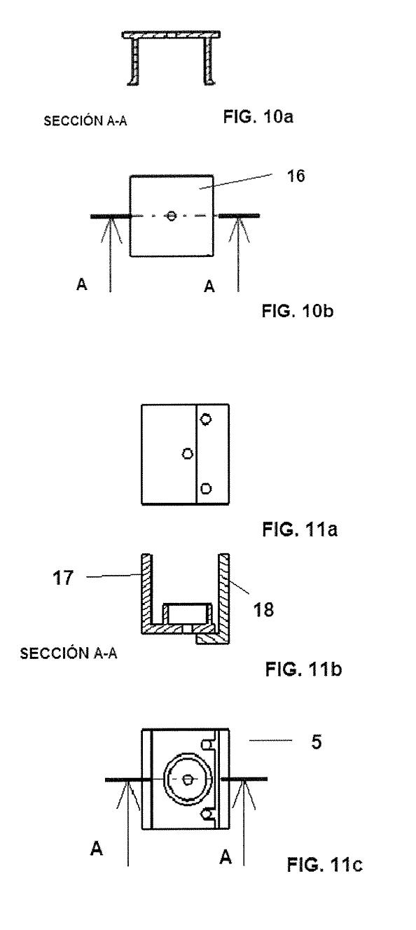

In principle, there are three preferred embodiments for the mechanical protection element 5. The first embodiment (FIGS. 5a and 5b) consists of a simple, preferably cylindrical, hollow tubular element coupled on a semi-rigid clamp which is in turn coupled to the surfaces of the material forming the composite structure. The second embodiment is shown in FIGS. 9a, 9b, 10a and 10b: it is a case 15 (FIGS. 9a and 9b) which is inserted on the edge of the material of the composite structure, which involves it being an optimal solution for large enough thicknesses. This case 15 comprises a cylindrical projection 41 in which the connection device would be housed. The mentioned case 15 further comprises a lid 16 for preventing stresses on the connection device. Finally, FIGS. 11a, 11b and 11c show a third embodiment considered as a single design for different ranges of thickness of the composite structure, since said thickness can be adjusted within the margin allowed by the movement of the parts 17 and 18 in relation to one another. This latter embodiment thus comprises a first element 17 for housing the protecting element 3 of the connection device. This element 17 will fix the protecting element 3 to one of the faces of the composite structure. The mentioned embodiment further comprises a second element 18 which is fixed to the first element 17 preferably by means of pins or screws, and which fixes the protecting element 3 of the connection device 1 to the opposite face of the composite structure.

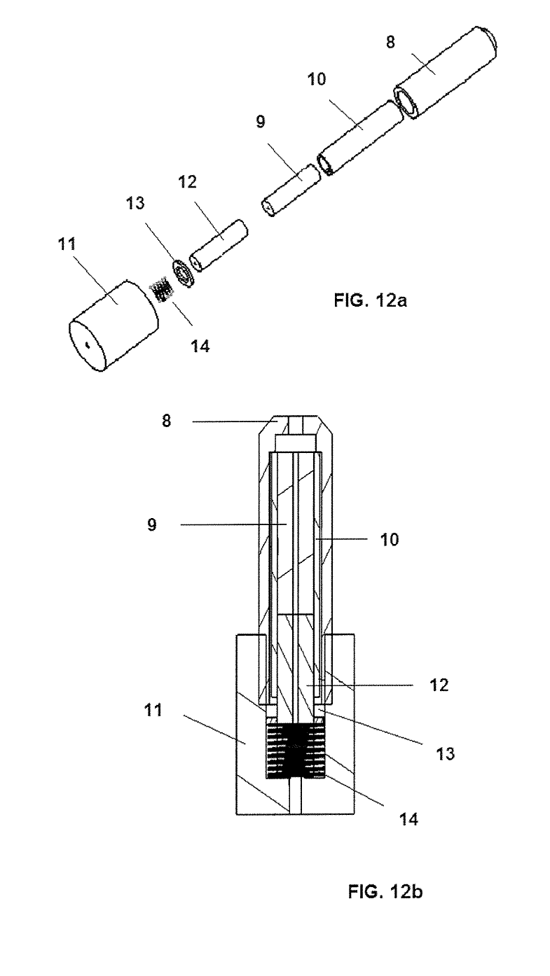

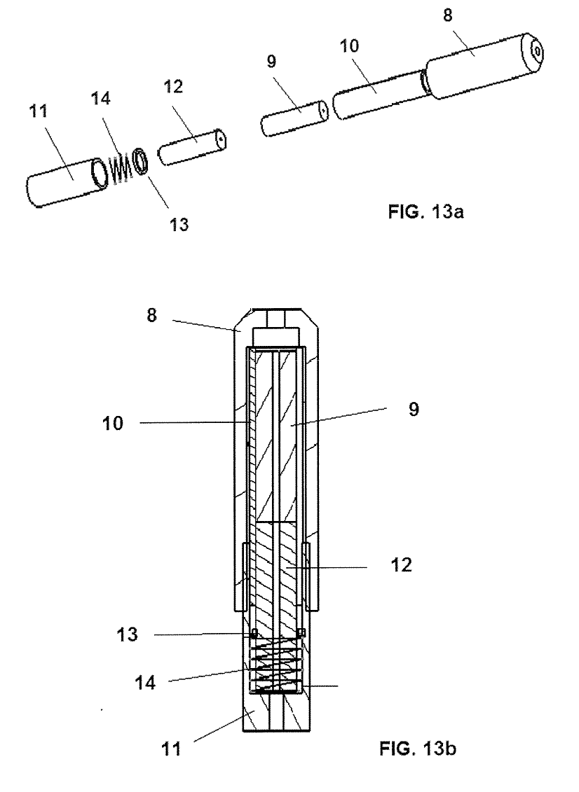

It must be taken into account that the geometry of the different parts embedded in the composite structure according to the invention does not necessarily have to be tubular or cylindrical, but rather they can have a shape which adapts as best possible to the sought requirements of non-penetration of the material. In this sense, the geometry will be such that it helps the flow of resin in the manufacturing process to cover and to suitably adapt to the required shape, preventing the formation of gaps and porosities reducing the local strength of the material. In relation to the conditions of the design, preparation and manufacture and installation of the connection device 1, as well as that of the different elements forming it, the essential requirements to be met according to the present invention are:
Temperature resistance: on one hand, resistance to the temperatures of the manufacturing process for the composite structure, and on the other hand, resistance to the service conditions for said structure between −60° C. and +200° C.
More aerodynamic external shape to prevent porosities and gaps, and to achieve better internal strength of the material, etc. The geometry must be adapted to the location in which the element is going to be placed, and based on a prior theoretical study of the flow of resin during curing, size this element in detail to assure that on one hand it is perfectly adjusted within the material, and that there are no resin gaps, which obviously would considerably jeopardize the mechanical strength of the material in this area. Finally, and no less important, the exit of the optical fiber from this part to the inside of the material will be done with a smooth and progressive design to assure absolute survival thereof during the stresses caused during curing.
Compatibility of expansions during and after the curing process for the composite structure: the materials forming the connection device (FIGS. 12a, 12b, 13a and 13b) must be thermally compatible with the composite. The dimensions of the elements forming the connection device, as well as the type of adjustment between them, must in turn be such that after curing the structure, the integrity of the assembly of the device and its functional properties remain intact.
Resistance to the environment: resistance to the aeronautical environment in terms of moisture, pressure, aggressive environments, etc., must also be considered in the selection of the materials of the connection device. The possibility of the formation of galvanic couples promoting corrosion is a factor that must be minimized by means of selecting the appropriate materials.
Tightness or sealing: this is an extremely important concept, not only during the service life of the connection device but especially during the actual curing process for the composite structure. Due to the temperature and pressure conditions existing in the curing process, the resin reaches a degree of fluidity such that if the appropriate measures are not taken, the proposed solution will not be viable due to the contamination of the resin in the area of optical contact of the fiber 7. Accordingly, in the process of installing the device in the composite structure, whether on an edge or protruding on the surface thereof, measures will be adopted for the purpose of preventing the flow of resin into the device 1 and into the threaded attachment of the first connection element 2 and the protecting element 3, since this flow would further prevent the subsequent removal of the mentioned parts 2 and 3, and their connection with the second connection element 4.
Non-penetration inside the structure: given that the main applications of these sensors are for structural component (composite structure) monitoring, it is obvious that the actual inclusion of the device should not entail deterioration of the mechanical properties of said elements (composite structures). In this sense, the dimensions of the connection device and of the elements forming it will be as small as possible and variable depending on the thickness of the structure to be monitored, especially in the event that the fiber protrudes through the edge of the composite structure. In the event that the fiber, and therefore the device, protrudes through the surface of the composite structure, it is of the utmost importance to protect the elements of the device 1 such that they are perfectly integrated in the structure through a series of additional layers (reinforcement 60). For either of the two previous cases, both for the fiber projecting through the surface and through the edge of the composite structure, additional layers will be introduced with the appropriate stepping sequence and number so that they are compensated and preventing residual stresses after curing the structure, as well as the presence of resin shortages or excess resin in the neighboring areas. For some cases, reinforcing the area of the structure where the device is embedded by means of riveted attachments, which will obviously meet the design conditions corresponding to this type of attachment (distances, minimum thicknesses, diameters, etc.), is not ruled out.
Functional requirements of the optical attachment of the fiber 7: the sealing of the assembly of the device, the narrow tolerances of the elements 9, 12 and element 10, as well as the pressure of the elastic element 14 (FIGS. 12a, 12b, 13a and 13b) are the design measures to assure the correct optical contact during the service conditions of the device, especially temperature variations, entrance of contaminants and transmitted mechanical vibrations.
Compatibility with manufacture and assembly operations. The installation of the connection device as well as its penetration depth will be such that they will allow subsequent works for planing the composite structures without damaging the integrity of the connection device.
Survival of the fiber 7: a series of essential measures will be taken to assure the survival of the fiber 7 during the assembly process. These measures will depend on each specific case and generally seek two objectives: first, to block the passage of the flow of resin to the area of the fiber 7, and second, to prevent shearing points in the optical fiber 7. For the first objective, the passage of resin will be blocked through the protection of the device with adhesive and sealing films which are easily removable but resistant to the manufacturing process. For the second case, depending on the distribution of layers of the structure and the thickness thereof, geometric details will be redesigned with the aim of eliminating any small radius producing sharp corners.

The modifications comprised within the scope defined by the following claims can be introduced in the embodiments described above.

1. A device (1) for connecting at least one optical fiber (7) embedded in a composite structure (50), said device (1) comprising a first connection element (2) which is embedded in the mentioned composite structure (50), internally comprising said at least one optical fiber (7), characterized in that the device (1) further comprises:
a protecting element (3) which is attached to the first connection element (2) during the manufacture and assembly of the composite structure (50), being embedded therein, such that it prevents the penetration of resin in the mentioned first connection element (2) during the curing of said structure (50);
a second connection element (4) comprising at least one optical fiber lead (7) and an elastic element (14), said second connection element (4) being attached to the first connection element (2) after the removal of the protecting element (3) once the curing of the structure (50) has ended, making the mentioned structure (50) start to operate, the at least one optical fiber (7) of the first connection element (2) and of the second connection element (4) thus being connected as a result of the elastic element (14).

2. The device (1) for connecting at least one optical fiber (7) embedded in a composite structure (50) according to claim 1, characterized in that said device (1) is located on one of the edges of the mentioned structure (50).

3. The device (1) for connecting at least one optical fiber (7) embedded in a composite structure (50) according to claim 1, characterized in that said device (1) is located on the surface of the mentioned structure (50), on a reinforcement (60) thereof, said reinforcement (60) being integrated in said structure (50) through a series of additional layers.

4. The device (1) for connecting at least one optical fiber (7) embedded in a composite structure (50) according to claim 1, characterized in that the mentioned second connection element (4) is attached to the first connection element (2) through a threaded attachment.

5. The device (1) for connecting at least one optical fiber (7) embedded in a composite structure (50) according to claim 4, characterized in that the threaded attachment is implemented externally to the mentioned first connection element (2).

6. The device (1) for connecting at least one optical fiber (7) embedded in a composite structure (50) according to claim 4, characterized in that the threaded attachment is implemented internally to the mentioned first connection element (2).

7. The device (1) for connecting at least one optical fiber (7) embedded in a composite structure (50) according to claim 1, characterized in that it further comprises a mechanical protection element (5) which is attached to the second connection element (4) once the structure (50) starts to operate, such that the first and second connection elements (2, 4) are mechanically protected, the stresses of any mechanical aggression on the device (1) being absorbed by the mentioned protection element (5).

8. The device (1) for connecting at least one optical fiber (7) embedded in a composite structure (50) according to claim 7, characterized in that the protection element (5) comprises a first element (17) for housing the protecting element (3) of the device (1), this element (1) fixing the protecting element (3) to one of the faces of the structure (50), further comprising a second element (18) which is fixed to the first element (17) and fixing the protecting element (3) to the opposite face of the structure (50), such that the protection element (5) is valid for different ranges of thickness of the composite structure (50) since said thickness can be adjusted to the margin allowed by the movement of the parts (17, 18) in relation to one another.
